(19) United States
(12) Patent Application Publication
(10) Pub. No.: US 2011/0264609 A1
(43) Pub. Date: Oct. 27, 2011

(54) PROBABILISTIC GRADIENT BOOSTED MACHINES

(75) Inventors: Chao Liu, Bellevue, WA (US); Yi-Min Wang, Bellevue, WA (US)

(73) Assignee: Microsoft Corporation, Redmond, WA (US)

(21) Appl. No.: 12/764,979

(22) Filed: Apr. 22, 2010

(51) Int. Cl. G06F 15/18

(52) U.S. Cl. 706/12

(57) ABSTRACT

Probabilistic gradient boosted machines are described herein. A probabilistic gradient boosted machine can be utilized to learn a function based at least in part upon sets of observations of a target attribute that is common across a plurality of entities and feature vectors that are representative of such entities. The sets of observations are assumed to accord to a distribution function in the exponential family. The learned function is utilized to generate values that are employed parameterize the distribution function, such that sets of observations can be predicted for different entities.

### BACKGROUND

Over the last several years, computers have advanced from high cost, low functioning machines to relatively low cost, high functioning machines that allow users thereof to perform relatively complex computational tasks. Specifically, processors have been developed that include multiple cores such that processing speed is much greater than it has been in the recent past. Additionally, an amount of memory on the processor has greatly increased over the last several years.

Machine learning is one type of discipline that can utilize these ever-advancing computational technologies. Machine learning is a scientific discipline that pertains to design and development of algorithms/functions that allow computer programs to intelligently evolve based upon observed data such as data from a sensor or retained in one or more databases. Gradient boosting is one form of machine learning technique that is commonly utilized for learning mathematical models. Generally, a gradient boosted machine is utilized to learn a function such that the function can output a value of a target attribute of an entity. Specifically, an entity can be represented by a feature vector, wherein the feature vector includes a plurality of attributes corresponding to the entity. Observations of a certain target attribute pertaining to the entity can be obtained and these observations together with the feature vector can be utilized to learn a function (through employment of a gradient boosted machine) that can be configured to predict a value for the target attribute for another entity of the same type (but with a different feature vector).

In an example, a computing device can have a feature vector corresponding thereto, wherein the feature vector includes values for various attributes such as I/O throughput, CPU utilization at different times, network traffic over a threshold period of time (e.g., network traffic in the last ten minutes), temperatures, amongst other attributes. When operating, the computing device may need to be rebooted for a variety of reasons, such as to install updates. An amount of time until a reboot is needed (hereinafter referred to as “time-to-reboot”) can be observed. Based at least in part upon the observation and the attributes, a function can be learned that is configured to predict a value of the target attribute (time-to-reboot) for another computing device with a different feature vector.

While gradient boosted machines are useful in a variety of settings, in some instances functions learned through utilization of gradient boosted machines may not provide a sufficient amount of data or desired information. For example, a parameter desirably observed can have fluctuations in such observations at different points in time. A function learned via a gradient boosted machine is not configured to provide information pertaining to the fluctuations, but instead utilizes averages of the fluctuations.

### SUMMARY

The following is a brief summary of subject matter that is described in greater detail herein. This summary is not intended to be limiting as to the scope of the claims.

Described herein are various technologies pertaining to utilizing a probabilistic gradient boosted machine to learn a function that can be utilized in connection with predicting a distribution of a target attribute. In more detail, observations of a target attribute can be obtained for entities of a particular type (e.g., over time). These entities can have feature vectors that describe such entities. Observations of the target attribute can accord to a particular distribution function in the exponential family. In a particular example that is provided for illustrative purposes, the entities may be computers, the feature vectors can include attributes such as I/O throughput, CPU utilization at different times, network traffic over a threshold period of time, temperature of rooms that house the computers, etc. Furthermore, the target attribute may be time-to-reboot, and several observations of the target attribute can be obtained.

A probabilistic gradient boosted machine can be provided with the feature vectors and the observations of the target attribute, and can be configured to learn a function that is utilized to output one or more values that are employed to parameterize the aforementioned distribution function. Utilization of value(s) output by the function as a parameter to the distribution function can substantially maximize a joint likelihood of all considered observations of the target attribute for the entities of the particular type. Accordingly, the function can be utilized in connection with the distribution function of the exponential family to predict distribution information pertaining to the target attribute for entities of the particular type (including entities not considered during the learning process and entities considered during the learning process but with different values for attributes in the feature vector).

This distribution information can be utilized in various contexts such as, for instance, preventative maintenance purposes, predicting uptime of a machine, etc.

Other aspects will be appreciated upon reading and understanding the attached figures and description.

### BRIEF DESCRIPTION OF THE DRAWINGS

FIG. 1 is a functional block diagram of an example system that facilitates utilizing a probabilistic gradient boosted machine to learn a function.

FIG. 2 is a graphical depiction of the mapping of an entity to predicted values of a target attribute through utilization of a function learned by way of a probabilistic gradient boosted machine.

FIG. 3 is a functional block diagram of an example system that facilitates predicting a distribution of a target attribute.

FIG. 4 is a flow diagram that illustrates an example methodology for learning a function through utilization of a probabilistic gradient boosted machine.

FIG. 5 is a flow diagram that illustrates an example methodology for utilizing a function learned by way of a probabilistic gradient boosted machine to predict a distribution of values of a certain target attribute for a particular entity.

FIG. 6 is an example computing system.

### DETAILED DESCRIPTION

Various technologies pertaining to probabilistic gradient boosted machines will now be described with reference to the drawings, where like reference numerals represent like elements throughout. In addition, several functional block diagrams of example systems are illustrated and described herein for purposes of explanation; however, it is to be understood that functionality that is described as being carried out by certain system components may be performed by multiple components. Similarly, for instance, a component may be configured to perform functionality that is described as being carried out by multiple components.

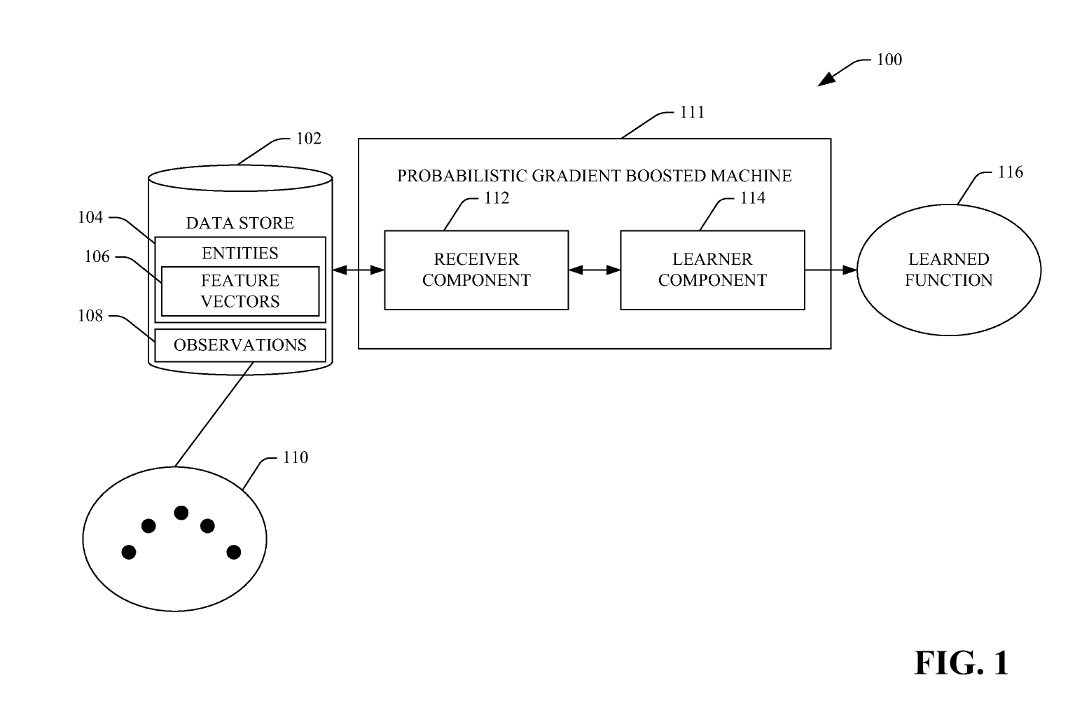

With reference to FIG. 1, an example system 100 that facilitates utilizing a probabilistic gradient boosted machine to learn a function is illustrated. As used herein, a probabilistic gradient boosted machine can refer to a system/component/algorithm that can be utilized to learn a function, wherein the learned function can be employed to output value(s) to parameterize a distribution function in the exponential family.

The system 100 comprises a data store 102 that includes computer readable data. That is, a computer processor can access the data store 102 and perform one or more processing functions on data stored in the data store 102. The data store 102 comprises data that identifies a plurality of entities 104 of a particular type. For example, the entities 104 may be computers, web pages, or any other suitable type of entity, object, person, thing, etc. The data store 102 further comprises feature vectors 106 that are representative of the entities 104. For example, each of the entities 104 may be represented, respectively, by a different feature vector. A feature vector can comprise values that are indicative of attributes of an entity. For instance, if an entity is a web page, then the feature vector 106 can include values indicative of document length, number of images, a time when the web page was most recently crawled, etc. Of course, any suitable entity that can be represented by a feature vector and that has a target attribute whose observations can change is contemplated and intended to fall under the scope of the hereto-appended claims.

The data store 102 may also comprise a plurality of observations 108 of a target attribute that pertains to the entities 104. As used herein, a target attribute can be an attribute pertaining to the entity, wherein values of the target attribute can vary under different conditions, and wherein it is desirable to predict values for the target attribute. Referring to the web page example provided above, a target attribute for a web page may be a daily visit number (a number of times in a day that the web page is visited). The observations 108 can accord to a distribution function in the exponential family. Specifically, each of the entities 104 may independently have observations of the target attribute pertaining thereto. An exploded view 110 of example observations of a particular target attribute with respect to a certain entity is shown for illustrative purposes. Example distribution functions in the exponential family to which the observations 108 may accord can be, but are not limited to, a normal distribution function, an exponential distribution function, a gamma distribution function, a chi-square distribution function, a beta distribution function, a (conditionally) Weibull distribution function, a Dirichlet distribution function, a Bernoulli distribution function, a binomial distribution function, a multinomial distribution function, a Poisson distribution function, a negative binomial distribution function, and a geometric distribution function.

The system 100 further comprises probabilistic gradient boosted machine 111 that can be utilized to learn a function. The probabilistic gradient boosted machine 111 comprises a receiver component 112 that is in communication with the data store 102 and can access the data store to obtain the entities 104, the corresponding feature vectors 106, and the observations 108. For example, the receiver component 112 can be an interface of some sort such as a bus, a port, etc. In another example, the receiver component 112 can be a form of software interface.

The probabilistic gradient boosted machine 111 can further comprise a learner component 114 that is in communication with the receiver component 112 and can receive the entities 104, the corresponding feature vectors 106, as well as the observations 108. The learner component 114 can then learn a function (a learned function) 116 based at least in part upon the feature vectors 106 and the observations 108. The learned function 116 may be in the form of a computer executable function. Moreover, the learned function 116 can be configured to substantially maximize a joint likelihood of the observations 108 for the entities 104 when values output by the learned function 116 are utilized to parameterize the distribution function. The learned function 116 may then be configured to receive a feature vector of an entity of the same type as the entities 104 and can be further configured to output value(s) based at least in part upon such feature vector. These value(s) may be utilized to parameterize the distribution function in the exponential family. The output of the distribution function can be a set of predicted values of the target attribute for the entity. This set of predicted values can be in the form of a distribution, and the distribution can be analyzed to obtain useful information regarding the entity. Utilization of the learned function 116 in connection with predicting values for a target attribute will be described in greater detail below.

Additional detail pertaining to operation of the learner component 114 will now be provided. In a more formal representation of a problem setting pertaining to probabilistic gradient boosted machines, it can be assumed that N are the number of entities to be considered: eᵢ=1, 2, . . . , N, and xᵢεRⁿ can represent the attributes for each entity. These attributes form feature vectors as mentioned above. For at least one of the entities, eᵢ, Nᵢ observations pertaining to a target attribute of the entity can be obtained:

t_{i,j}˜f(t|θᵢ)j=1,2, . . . , Nᵢ,

where f(t|θᵢ) is a distribution function that belongs to the exponential family, wherein t is a variable and θᵢ is a value utilized to parameterize the function.

Given the above, it is desirable to locate a function F(x) that substantially maximizes the joint likelihood of all observations of the target attribute across entities of the same type. Formally this can be expressed as follows:

$${F}^{*} = {argmax}_{F} {\prod }_{i = 1}^{N} {\prod }_{j = 1}^{{N}_{i}} Prob ( {t}_{i , j} \vert F ( {x}_{i} ) ) .$$

Additionally, F*(x) is desirably interpretable such that particular features of the feature vectors can be determined as being more or less relevant than other features. Furthermore, it can be noted that θ is not necessarily one-dimensional.

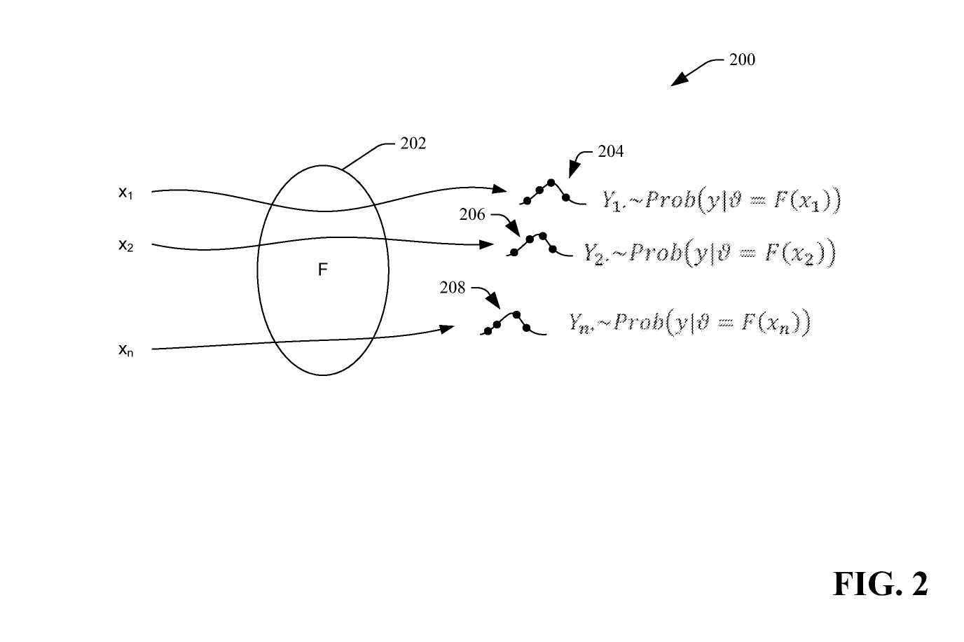

Referring briefly to FIG. 2, an example depiction 200 that illustrates how the desired function maps to observations is illustrated. The depiction 200 comprises a learned function 202 F, wherein particular feature vectors for entities of a substantially similar type are provided to the function 202. The output of the function 202 for each of the feature vectors is a parameterization of a probabilistic distribution function that can result in a substantially maximized joint likelihood of observing observations 204, 206 and 208 that correspond to entities represented by the feature vectors. That is, for the feature vector x₁, output of the function 202 is F(x₁), which can be utilized to parameterize a probabilistic distribution that governs the generation of observations Y₁ given such feature vectors. Similarly, for the feature vector xₙ, the output of the function F(xₙ) can be utilized to parameterize a probabilistic distribution that governs the generation of observations Yₙ.

Referring again to FIG. 1, more detail pertaining to the learner component 114 is provided. As was indicated previously, f(t|θ) is an exponential function that belongs to the exponential family, which can be represented as follows:

f(t|θ)=h(t)c(θ)exp {η(θ)T(t)},

where h, c, η, and T are known functions. Taking the log of both sides results in the following:

log(f(t|θ))=log(h(t)c(θ))+η(θ)T(t),

such that the equivalent likelihood function for observations pertaining to entity eᵢ is

LL(Dᵢ|θᵢ)=Nᵢ log(c(θᵢ))+η(θᵢ)Σⱼ₌₁^{N}^{ᵢ}T(t_{i,j}), (1)

where Dᵢ={t_{i,j}}ⱼ₌₁^{N}^{_{i.}}

Taking the negative log likelihood as the cost function for each entity results in the following:

φ(Dᵢ,F(xᵢ))=−Nᵢ log(c(F(xᵢ)))−η(F(xᵢ))Σⱼ₌₁^{N}^{ᵢ}T(t_{i,j}), (2)

and the total loss is

$$( D , F ( x ) ) = {\sum }_{i = 1}^{N} φ ( {D}_{i} , F ( {x}_{I} ) ) .$$

The learner component 114 desirably learns the following function:

$$F ( x ) = {F}_{m} ( x ) = {\sum }_{k = 0}^{m - 1} {F}_{i} ( x ) ,$$

which is a summation. Accordingly, the learner component 114 first learns F₀(x). Since

F₀(x)=argmin_{ρ} [symbol] (D,ρ) (3)

can be derived from what has been provided above, the following can be ascertained:

$$\begin{matrix} ( D , ρ ) = {\sum }_{i = 1}^{N} [ - {N}_{i} \frac{{c}^{′} ( ρ )}{c ( ρ )} - {η}^{′} ( ρ ) {{\sum }_{j = 1}}^{{N}_{i}} T ( {t}_{i , j} ) ] & ( 4 ) \\ = - \frac{{c}^{′} ( ρ )}{c ( ρ )} 𝒩 - {η}^{′} ( ρ ) 𝒯 & ( 5 ) \\ = g ( ρ ) , & ( 6 )\end{matrix}$$

where N=Σᵢ₌₁^{N}Nᵢ, τ=Σᵢ₌₁^{N}Σⱼ₌₁^{N}ᵢT(t_{i,j}) and ρ is a constant that minimizes [symbol] (D,ρ).

The learner component 114 can utilize various techniques to find F₀(x). One such technique is by directly minimizing [symbol] (D,ρ) through line search. Another example technique is to numerically solve g(ρ)=0 through Newton-Raphson iterations. This second technique is shown and described below for illustrative purposes. First, the learner component 114 can obtain the following:

$${g}^{′} ( ρ ) = \frac{{c}^{″ ( ρ )} c ( ρ ) - {c}^{′ ( ρ )} {c}^{′ ( ρ )}}{{c}^{2} ( ρ )} 𝒩 - {η}^{″} ( ρ ) 𝒯$$

such that

$${ρ}^{( n + 1 )} = {ρ}^{( n )} - \frac{g ( {ρ}^{( n )} )}{{g}^{′} ( {ρ}^{n} )} .$$

Thereafter the functional derivative (the pseudo response) can be calculated as follows:

$$\begin{matrix}{\tilde{y}}_{i} = - \frac{\partial φ ( {D}_{i} , F ( {x}_{i} ) )}{\partial F ( {x}_{i} )} & ( 7 ) \\ = {N}_{i} {log}_{{θ}_{i}}^{′} ( c ( {θ}_{i} ) ) + {η}_{{θ}_{i}}^{′} ( {θ}_{i} ) {\sum }_{j = 1}^{{N}_{I}} T ( {t}_{i , j} ) {\vert}_{{θ}_{i} = F ( {x}_{i} )} & ( 8 ) \\ = {N}_{i} \frac{{c}^{′} ( {θ}_{i} )}{c ( {θ}_{i} )} + {η}_{{θ}_{i}}^{′} ( {θ}_{i} ) {\sum }_{j = 1}^{{N}_{i}} T ( {t}_{i , j} ) {\vert}_{{θ}_{i} = F ( {x}_{i} )} & ( 9 )\end{matrix}$$

These functional derivatives can then be approximated by the learner component 114. Specifically, the learner component 114 can approximate {\tilde{y}ᵢ}ᵢ₌₁^{N}, which are actually the gradients in the following function space:

$${α}_{m} = {argmin}_{α} {\sum }_{i = 1}^{N} {( {\tilde{y}}_{i} - β h ( {x}_{i} \text{:} α ) )}^{2} ,$$

where α and β are constants that can minimize the above function. This can allow for obtaining of the base learner at the mth iteration h(xᵢ:αₘ).

The learner component 114 can then perform a line search to locate the step size for the following descent:

$${ρ}_{m} = {argmin}_{ρ} {\sum }_{i = 1}^{N} φ ( {D}_{i} , {θ}_{i} ) {\vert \vert}_{{θ}_{i} = F ( {x}_{i} ) + ρ h ( {x}_{i} \text{:} {α}_{m} )} ,$$

which can be solved through numerical methods in general or analytically when the form of c(θ) and η(θ) are tractable. The function can then be updated through the following equation:

Fₘ(x)=Fₘ₋₁(x)+ρₘh(x:αₘ)

Two concrete problems will now be described to illustrate operation of the probabilistic gradient boosted machine 111 and possible applications of the learned function 116. In a first example, the data store 102 may include data representative of N computers within a network (e.g., eᵢ=1, 2, . . . , N), and each computer eᵢ can be accompanied by observations of time-to-reboot of such computers, which can accord to an exponential distribution t_{i,j}˜f(t|θᵢ) j=1, 2, . . . , Nᵢ.

The data store 102 may also comprise a plurality of feature vectors xᵢεRⁿ, wherein a feature vector exists for each computer eᵢ. Such a feature vector may include values for various attributes, including CPU utilization, network traffic over a last 10 minutes, room temperatures, etc. Thus, it is desired that the probabilistic gradient boosted machine 111 learns a function λᵢ=F(xᵢ) that substantially maximizes the joint likelihood of substantially all observed time-to-reboot data for the computers:

$${F}^{*} = {argmax}_{F} {\prod }_{i = 1}^{N} {\prod }_{j = 1}^{{N}_{i}} Exponential ( {t}_{i , j} \vert F ( {x}_{i} ) ) .$$

If F*(x) is found by the learner component 114, such F*(x) can be utilized to predict observations for other computers and such predictions can be utilized for preemptive correction purposes.

If an exponential distribution function is utilized as the probability for observation, the following can be ascertained:

$$f ( t / β ) = \frac{1}{β} exp \{ - t / β \} .$$

If θ=1/β, then f(t|θ)=exp{−θt} results such that c(θ)=θ, η(θ)=θ, and T(t)=−t.

Thereafter, based on Equation (5) the following can be obtained:

$$g ( ρ ) = \frac{{c}^{′} ( ρ )}{c ( ρ )} 𝒩 - {η}^{′} ( ρ ) 𝒯 = - \frac{𝒩}{ρ} - 𝒯 = 0 ,$$

which provides

$${F}_{0} ( x ) = - \frac{𝒩}{𝒯} .$$

Additionally, the pseudo response given by Equation (9) can be as follows:

$${\tilde{y}}_{i} = {N}_{i} \frac{1}{{θ}_{i}} + {\sum }_{j = 1}^{{N}_{i}} T ( {t}_{i , j} ) {\vert}_{{θ}_{i} = F ( {x}_{i} )}$$

This can be utilized to provide the following computer-executable algorithm, which can be employed by the learner component 114 to learn the learned function 116:

$$1 \text{:} {F}_{0} ( x ) = \frac{𝒯}{𝒩} , where 𝒩 = {\sum }_{i = 1}^{N} {N}_{i} and 𝒯 = {\sum }_{i = 1}^{N} {\sum }_{i = j}^{{N}_{i}} {t}_{i , j}$$

$$2 \text{:} For m = 1 to M \text{:}$$

$$3 \text{:} {\tilde{y}}_{i} = - {N}_{i} + \frac{{\sum }_{j = 1}^{{N}_{i}} T ( {t}_{i , j} )}{{θ}_{i}} {\vert}_{{θ}_{i} = {F}_{m - 1 ( x )}} \\ 4 \text{:} {α}_{m} = {argmin}_{α , β} {\sum }_{i = 1}^{N} {[ {\tilde{y}}_{i} - β h ( {x}_{i} ; α ) ]}^{2}$$

$$5 \text{:} {ρ}_{m} = {argmin}_{ρ} {\sum }_{i = 1}^{N} φ ( {y}_{i} , {F}_{m - 1} ( {x}_{i} ) + ρ h ( {x}_{i} ; {α}_{m} ) )$$

$$6 \text{:} {F}_{m} ( x ) = {F}_{m - 1} ( x ) + {ρ}_{m} h ( x ; {α}_{m} )$$

$$7 \text{:} End For$$

In a second example problem it can be assumed that the data store 102 comprises entities that are a plurality of web pages eᵢ=1, 2, . . . , N. For each page eᵢ daily visit numbers for Nᵢ days are observed. These daily visit numbers can be assumed to come from a Poisson distribution as follows:

t_{i,j}˜Poisson(t|λᵢ)j=1,2, . . . , Nᵢ

Each page eᵢ can have a feature vector xᵢεRⁿ corresponding thereto, wherein features in the feature vector can include document length, static rank, number of images, time that the page was last crawled, etc. In this example, it is desired that the probabilistic gradient boosted machine 111 find a function F(x) such that the following is substantially maximized:

$${\prod }_{i = 1}^{N} {\prod }_{j = 1}^{{N}_{i}} Poisson ( t \vert {λ}_{i} = F ( {x}_{i} ) ) .$$

If F*(x) is found, besides being able to understand how each factor is related to web page popularity, predictions can be made about popularity for pages that have not yet been observed in a log. Because of such predictions, resulting popularity scores would have much larger coverage than previous methods based solely on log observed pages.

The probabilistic gradient boosted machine 111 can learn the learned function 116 for the problem as follows: Using Poisson distribution as the probabilistic function for observing observations, the following is obtained:

$$f ( t / β ) = \frac{1}{t !} {λ}^{x} exp \{ - λ \}$$

If θ=λ, then

$$f ( t \vert θ ) = \frac{1}{t !} exp \{ - θ \} exp \{ t log ( θ ) \} ,$$

such that c(θ)=exp{−θ} and η(θ)=log(θ) and T(t)=t. Thereafter, based on Equation (5), the following can be obtained:

$$g ( ρ ) = - \frac{{c}^{′} ( ρ )}{c ( ρ )} 𝒩 - {η}^{′} ( ρ ) 𝒯 = 𝒩 - \frac{𝒯}{ρ} = 0 ,$$

which provides

$${F}_{0} ( x ) = \frac{𝒯}{𝒩} .$$

Similarly, the pseudo response based upon Equation (9) can be as follows:

$${\tilde{y}}_{i} = - {N}_{i} + \frac{{\sum }_{j = 1}^{{N}_{i}} T ( {t}_{i , j} )}{{θ}_{i}} {\vert}_{{θ}_{i} = F ( {x}_{i} ) .}$$

This can provide the following computer-executable algorithm that can be utilized by the learner component 114 to learn the learned function 116 for the problem laid out above. Thereafter, such learned function can be employed to predict popularity distributions for web pages that have not been observed.

$$1 \text{:} {F}_{0} ( x ) = \frac{𝒯}{𝒩} , where 𝒩 = {\sum }_{i = 1}^{N} {N}_{i} and 𝒯 = {\sum }_{i = 1}^{N} {\sum }_{i = j}^{{N}_{i}} {t}_{i , j}$$

$$2 \text{:} For m = 1 to M \text{:}$$

$$3 \text{:} {\tilde{y}}_{I} = - {N}_{i} + \frac{{\sum }_{j = 1}^{{N}_{i}} T ( {t}_{i , j} )}{{θ}_{i}} {\vert}_{{θ}_{i} = {F}_{m - 1 ( x )}} \\ 4 \text{:} {α}_{m} = {argmin}_{α , β} {\sum }_{i = 1}^{N} {[ {\tilde{y}}_{i} - β h ( {x}_{i} ; α ) ]}^{2}$$

$$5 \text{:} {ρ}_{m} = {argmin}_{ρ} {\sum }_{i = 1}^{N} φ ( {y}_{i} , {F}_{m - 1} ( {x}_{i} ) + ρ h ( {x}_{i} ; {α}_{m} ) )$$

$$6 \text{:} {F}_{m} ( x ) = {F}_{m - 1} ( x ) + {ρ}_{m} h ( x ; {α}_{m} )$$

$$7 \text{:} End For$$

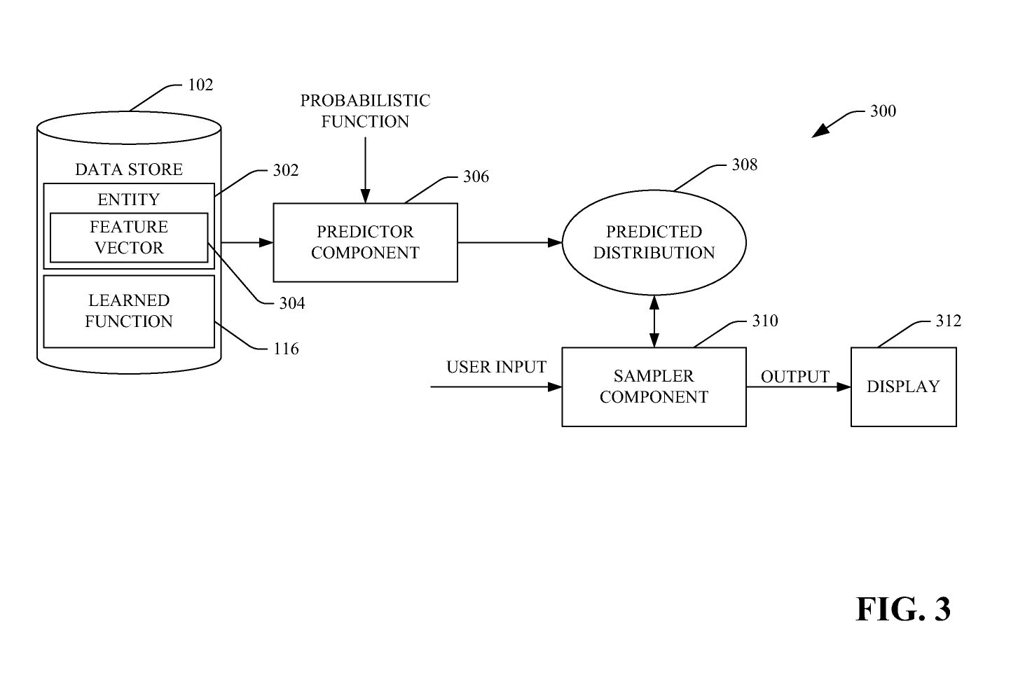

Now referring to FIG. 3, an example system 300 that facilitates utilizing a probabilistic gradient boosted machine to learn a function that can be employed in connection with predicting a distribution of values of a target attribute for a particular entity is illustrated. In this example, the data store 102 comprises an entity 302 that has not been considered when the learned function was learned, and it is desirable to predict values of a target attribute for such entity 302. The entity 302 has a feature vector 304 corresponding thereto. The data store 102 can also comprise the learned function 116 that has been learned as described above for a particular distribution function in the exponential family.

A predictor component 306 can access the data store 102 and retrieve the feature vector 304 and the learned function 116. The predictor component 306 can also include a probabilistic function (a distribution function) that belongs to the exponential family with respect to which the learned function 116 has been learned. The predictor component 306 can utilize the learned function 116 to output a value or a series of values based at least in part upon the feature vector 304, and such value or series of values can be utilized to parameterize the probabilistic function as described above. The output of the predictor component 306 can be a predicted distribution 308 of values of the target attribute. Such predicted distribution 308 can be caused to be stored in a computer-readable medium of a computing device, such as in memory. In an example, the entity being considered may be a computing device, and the predictor component 306 can be configured to predict values of the target attribute pertaining to operation of the computing device (e.g., time-to-reboot, future processing utilization, . . . ).

The system 300 may optionally comprise a sampler component 310 that can sample from the predicted distribution 308 based at least in part upon user input. For example, the sampler component 310 can generate an output that is indicative of the predicted distribution 308 of the target attribute of interest. In another example, the user input may indicate a certain set of preconditions, and the sampler component 310 can sample the predicted distribution 308 to output probabilistic data given the preconditions input by the user. In a concrete example, a user may wish to have some indication of when a computer may need to be rebooted. Thus, the user may provide inputs that request information pertaining to a probability as to the computer needing rebooted within a next three days. In another example, the user input may indicate that the computer has not been rebooted for seven days, and the user would like to know a probability that the computer will need to be rebooted within the next two days. The sampler component 310 can process the predicted distribution 308 to output information that is desired by the user. The system 300 can further include a display 312, and output of the sampler component 310 can be provided to the user on the display 312. Of course, in other embodiments the output need not be provided to the display 312 but can be stored in a computer readable medium such as a flash drive, memory, hard drive, etc. Moreover, the sampler component 308 may not be needed to obtain data pertaining to the predicted distribution of the target value. For example, once the distribution is fully parameterized, sampling need not be undertaken to obtain, for example, distribution mean, conditional probabilities, etc., as such data can be obtained from the analytical form of the fully parameterized distributions

As can be ascertained, probabilistic gradient boosted machines have several advantages over conventional gradient boosted machines. Specifically, conventional gradient boosted machines are configured to learn functions that assign a single predicted value for a target attribute. Thus, for instance, a gradient boosted machine can learn a function that provides an output that indicates an average time-to-reboot for a computer (e.g., two days). In actuality, the distribution of time-to-reboot, however, may be quite wide such that the time to reboot is nearly as likely to be five days as it is to be two days. Probabilistic gradient boosted machine can be utilized to learn functions that can be employed to obtain such information, which is richer than that which can be provided by functions learned by way of gradient boosted machines in many scenarios.

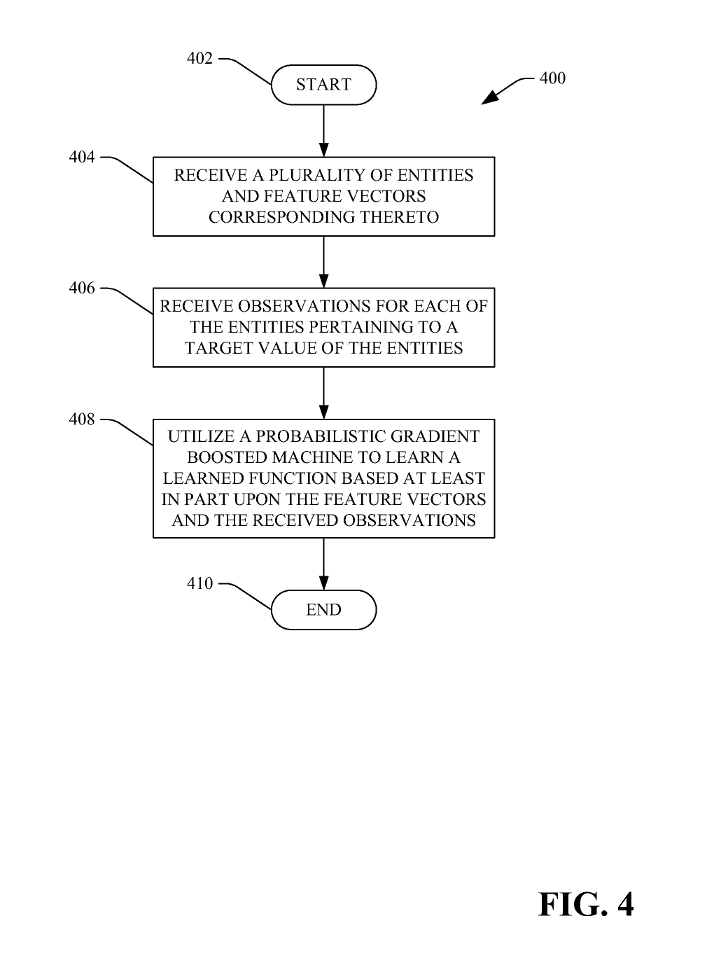

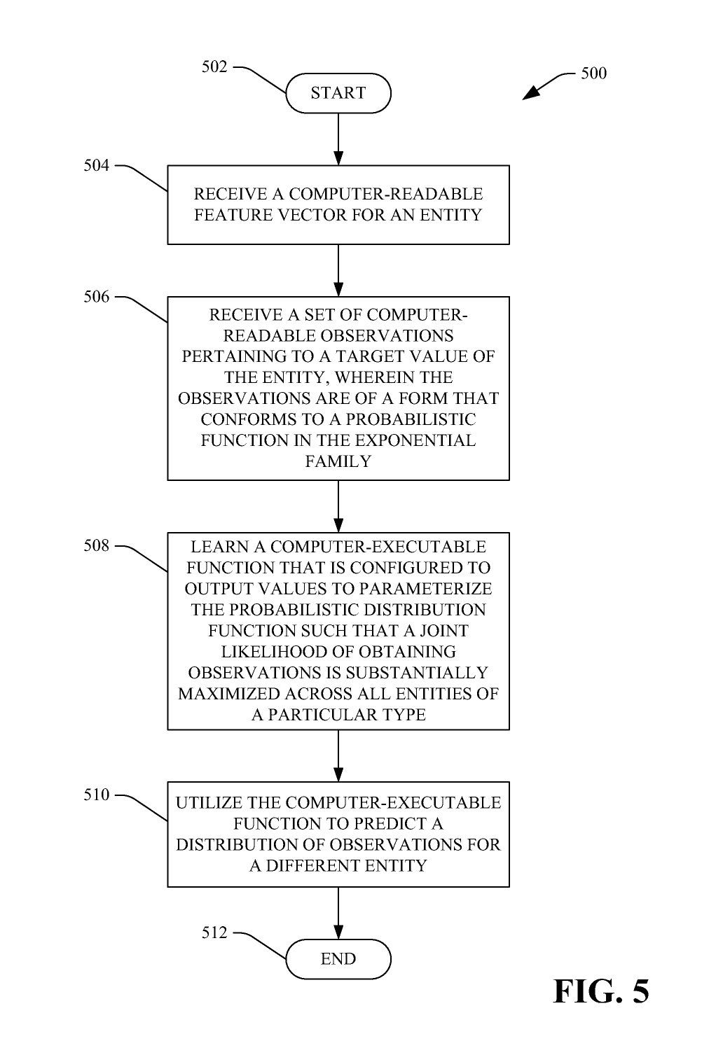

With reference now to FIGS. 4-5, various example methodologies are illustrated and described. While the methodologies are described as being a series of acts that are performed in a sequence, it is to be understood that the methodologies are not limited by the order of the sequence. For instance, some acts may occur in a different order than what is described herein. In addition, an act may occur concurrently with another act. Furthermore, in some instances, not all acts may be required to implement a methodology described herein.

Moreover, the acts described herein may be computer-executable instructions that can be implemented by one or more processors and/or stored on a computer-readable medium or media. The computer-executable instructions may include a routine, a sub-routine, programs, a thread of execution, and/or the like. Still further, results of acts of the methodologies may be stored in a computer-readable medium, displayed on a display device, and/or the like. The computer-readable medium may be a non-transitory medium, such as memory, hard drive, CD, DVD, flash drive, or the like.

Referring now to FIG. 4, a methodology 400 that facilitates learning a function through utilization of a probabilistic gradient boosted machine is illustrated. The methodology 400 begins at 402, and at 404 a plurality of entities and feature vectors corresponding thereto are received. The entities may be of the same type, such as computers, web pages, etc.

At 406, various observations pertaining to a target attribute of the entities is received for each of the entities. That is, observations of the aforementioned target attribute may exist for each of the entities and these observations can be received together with the feature vectors corresponding to the entities.

At 408, a probabilistic gradient boosted machine is employed to learn a function based at least in part upon these feature vectors and the received observations for the entities. As described above, the probabilistic gradient boosted machine can learn the learned function such that when a value output by the learned function is used to parameterize a distribution function of the exponential family, a joint likelihood of the observations over the entities is substantially maximized. The learned function may then be utilized to predict a distribution of values of the target attribute for an entity that is non-identical to the entities considered when learning the learned function. The methodology 400 completes at 410.

Now referring to FIG. 5, an example methodology 500 that facilitates learning a function through utilization of a probabilistic gradient boosted machine is illustrated. The methodology 500 starts at 502, and at 504 a computer readable feature vector is received for each of a plurality of entities, wherein the feature vectors include attributes that are representative of the entities, and wherein the feature vectors are non-identical to one another.

At 506, a set of computer readable observations pertaining to a target attribute of the entities is received, wherein such observations are of a form that conforms to a probabilistic distribution function in the exponential family. The conformance of the observations to the probabilistic distribution function can be assumed and/or learned through analysis, which is the common base (and/or assumptions) of statistics.

At 508, a computer executable function is learned that is configured to parameterize the probabilistic distribution function such that a joint likelihood of obtaining the aforementioned observation is substantially maximized over each of the entities considered when the computer executable function is utilized to output a value that is employed to parameterize the probabilistic distribution function.

At 510, the computer executable function (learned by way of a probabilistic gradient boosted machine) is utilized to predict a distribution of values for the target attribute for a different entity (e.g., an entity that was not utilized in connection with learning the probabilistic gradient boosted machine). The methodology 500 completes at 512.

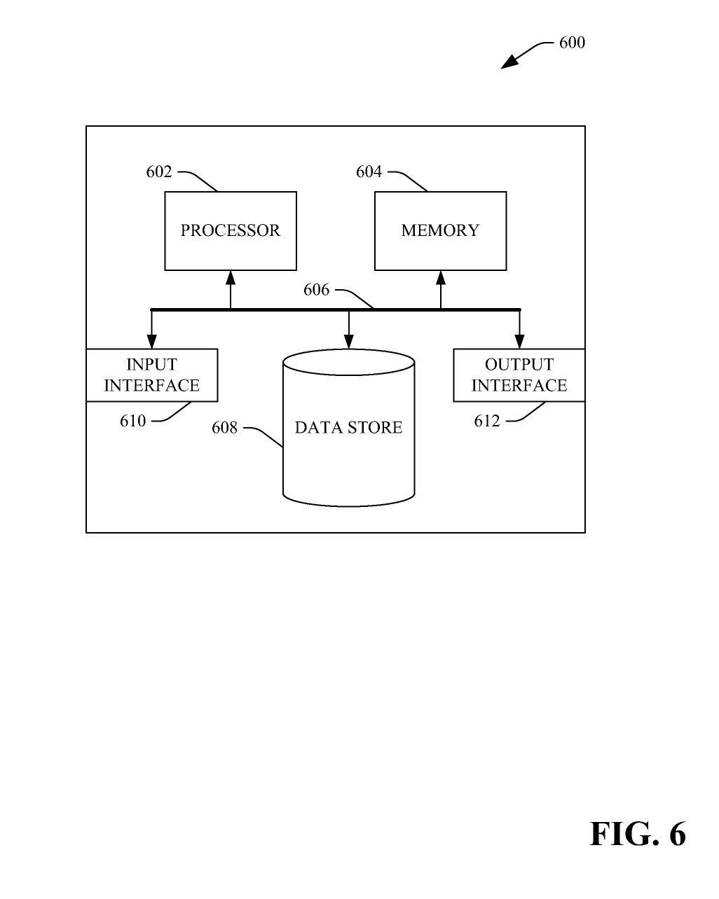

Now referring to FIG. 6, a high-level illustration of an example computing device 600 that can be used in accordance with the systems and methodologies disclosed herein is illustrated. For instance, the computing device 600 may be used in a system that supports learning a function through utilization of a probabilistic gradient boosted machine. In another example, at least a portion of the computing device 600 may be used in a system that supports making predictions of values of a parameter through utilization of the learned function. The computing device 600 includes at least one processor 602 that executes instructions that are stored in a memory 604. The memory 604 may be or include RAM, ROM, EEPROM, Flash memory, or other suitable memory. The instructions may be, for instance, instructions for implementing functionality described as being carried out by one or more components discussed above or instructions for implementing one or more of the methods described above. The processor 602 may access the memory 604 by way of a system bus 606. In addition to storing executable instructions, the memory 604 may also store observations, feature vectors, data that identifies entities, etc.

The computing device 600 additionally includes a data store 608 that is accessible by the processor 602 by way of the system bus 606. The data store 608 may be or include any suitable computer-readable storage, including a hard disk, memory, etc. The data store 608 may include executable instructions, observations, entities, feature vectors, etc. The computing device 600 also includes an input interface 610 that allows external devices to communicate with the computing device 600. For instance, the input interface 610 may be used to receive instructions from an external computer device, from a user, etc. The computing device 600 also includes an output interface 612 that interfaces the computing device 600 with one or more external devices. For example, the computing device 600 may display text, images, etc. by way of the output interface 612.

Additionally, while illustrated as a single system, it is to be understood that the computing device 600 may be a distributed system. Thus, for instance, several devices may be in communication by way of a network connection and may collectively perform tasks described as being performed by the computing device 600.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices. Furthermore, a component or system may refer to a portion of memory and/or a series of transistors.

Moreover, systems described herein may be comprised by a portable computing device, such as a mobile telephone. Additionally or alternatively, systems described herein can be comprised by a server, such that a system can be accessed by a user through utilization of a web browser.

It is noted that several examples have been provided for purposes of explanation. These examples are not to be construed as limiting the hereto-appended claims. Additionally, it may be recognized that the examples provided herein may be permutated while still falling under the scope of the claims.

What is claimed is:

1. A method comprising the following computer-executable acts:
receiving a plurality of computer-readable feature vectors that are representative of a corresponding plurality of entities, wherein the entities are of a certain type;
receiving computer-readable sets of observations for each of the plurality of entities, wherein the observations are observations of a target attribute of the entities, wherein the observations are assumed to conform to a distribution function in the exponential family;
based at least in part upon the sets of observations and the computer-readable feature vectors, utilizing a probabilistic gradient boosted machine to learn a learned function, wherein the learned function is configured for utilization in connection with predicting a set of values of the target attribute for an entity that is non-identical to entities in the plurality of entities.

2. The method of claim 1, wherein the learned function is configured to output a value to parameterize the distribution function.

3. The method of claim 2, wherein the learned function is configured to substantially maximize a joint likelihood of observing the sets of observations for the entities in the plurality of entities.

4. The method of claim 1, wherein the set of values of the target attribute is determined based at least in part upon a feature vector corresponding to the entity.

5. The method of claim 1, further comprising configuring sensors on the plurality of entities to generate the sets of observations.

6. The method of claim 1, wherein the entity is a computer, and wherein the target attribute is related to the computer.

7. The method of claim 1, wherein a computing device is configured to execute the method of claim 1.

8. The method of claim 7, wherein the computing device is a portable computing device.

9. The method of claim 1, wherein the distribution function is one of a normal distribution function, an exponential distribution function, a gamma distribution function, a chi-square distribution function, a beta distribution function, a Weibull distribution function, a Dirichlet distribution function, a Bernoulli distribution function, a binomial distribution function, a multinomial distribution function, a Poisson distribution function, a negative binomial distribution function, or a geometric distribution function.

10. The method of claim 1, further comprising utilizing a sampling algorithm to sample from the set of values.

11. A system comprising the following computer-executable components:
a receiver component that receives a plurality of feature vectors that are representative of a plurality of entities of a particular type and a plurality of sets of observations, wherein each observation in the sets of observations are of a target attribute pertaining to the plurality of the entities, wherein the sets of observations accord to a distribution function in the exponential family; and
a learner component that learns a learned function based at least in part upon the sets of observations and the plurality of feature vectors, wherein the learned function is configured to output a value that is used to parameterize the distribution function such that a joint likelihood of observing the sets of observations over the plurality of entities is substantially maximized.

12. The system of claim 11, further comprising a predictor component that receives the distribution function, the learned function, and a feature vector that is representative of an entity of the particular type, wherein the predictor component is configured to output a predicted set of values of the target attribute for the entity based at least in part upon the distribution function, the learned function, and the feature vector.

13. The system of claim 12, wherein the feature vector has values different from values of the feature vectors corresponding to the plurality of entities.

14. The system of claim 12, further comprising a sampler component that is configured to execute a sampling algorithm over the set of values and output data pertaining to a distribution of the set of values.

15. The system of claim 14, wherein the sampler component is configured to receive user input and output the data pertaining to the distribution based at least in part upon the user input.

16. The system of claim 12, wherein the entity is a computing device, and wherein the predictor component is configured to predict values of the target attribute pertaining to operation of the computing device.

17. The system of claim 11, wherein a server comprises the receiver component and the learner component.

18. The system of claim 11, further comprising a plurality of sensors that are configured to sense the sets of observations for the plurality of entities.

19. The system of claim 11, wherein the distribution function is one of a normal distribution function, an exponential distribution function, a gamma distribution function, a chi-square distribution function, a beta distribution function, a Weibull distribution function, a Dirichlet distribution function, a Bernoulli distribution function, a binomial distribution function, a multinomial distribution function, a Poisson distribution function, a negative binomial distribution function, or a geometric distribution function.

20. A computer-readable medium comprising instructions that, when executed by a processor, cause the processor to perform acts comprising:
receiving a plurality of sets of observations with respect to a corresponding plurality of entities, wherein each of the plurality of sets of observations pertain to a target attribute that is common across the plurality of entities, wherein the entities are each of a certain type, and wherein the plurality of sets of observations accord to a distribution function in the exponential family;
receiving a plurality of feature vectors that correspond to the plurality of entities, wherein the feature vectors comprises values indicative of pluralities of attributes of the plurality of entities, wherein the feature vectors are non-identical to one another; and
learning a learned function through utilization of a probabilistic gradient boosted machine based at least in part upon the sets of observations and the plurality of feature vectors, wherein the learned function is configured to compute values to parameterize the distribution function such that the distribution function, when parameterized by a value computed by the learned function, is configured to substantially maximize a joint likelihood of the sets of observations over the plurality of entities.
